(19) United States
(12) Patent Application Publication
(10) Pub. No.: US 2024/0078621 A1
(43) Pub. Date: Mar. 7, 2024

(54) Artificial Intelligence-Assisted Virtual Real Estate Closing Platform

(71) Applicant: Aurum Title, LLC, Dallas, TX (US)

(72) Inventors: Raymond Hindieh, Dallas, TX (US); Brian Gramlich, Dallas, TX (US)

(21) Appl. No.: 18/102,657

(22) Filed: Jan. 27, 2023

Related U.S. Application Data
(60) Provisional application No. 63/403,337, filed on Sep. 2, 2022.

(51) Int. Cl. G06Q 50/16

(52) U.S. Cl. CPC G06Q 50/167

(57) ABSTRACT

This disclosure describes a system and method for an artificial intelligence-assisted virtual closing proceeding. The system includes a web portal and an AI-assisted virtual assistant configured to communicate and interface with human participants that may include a buyer, seller, lender, notary, closing agent, lawyer, and real estate agent via the web portal. The virtual assistant communicates with the human participants to collect data and documents via the web portal, automatically prepare closing documents using information from the collected data and documents. The virtual assistant is able to identify and verify the buyer and seller who appear remotely in the videoconferencing session, present the closing documents to the buyer and seller, enable remote execution of the closing documents by the buyer and seller, actively monitor the remote execution of the closing documents, enable and actively monitor remote notarizing of the closing documents, and store the executed documents in a secure database.

### RELATED APPLICATION

This patent application claims the benefit of U.S. Provisional Patent Application No. 63/403,337 filed on Sep. 2, 2022, which is incorporated herein by reference in its entirety.

### FIELD

The present disclosure relates generally to electronic transactions, and in particular to an artificial intelligence-assisted virtual real estate closing system and method.

### BACKGROUND

A “closing” is the final phase of mortgage loan processing where the property title passes from the seller to the buyer. During the closing process, also called settlement or account settlement, the participants review, authorize, sign, and date numerous legal documents in front of a notary in order to signify the closing of the escrow account and complete the property purchase process. The list of required closing documents typically includes the closing disclosure, promissory note, and deed of trust.

### BRIEF DESCRIPTION OF THE DRAWINGS

FIG. 1 is a simplified block diagram of an exemplary embodiment of a system and method for artificial intelligence-assisted virtual closing according to the teachings of the present disclosure;

FIG. 2 is a more detailed block diagram of an exemplary embodiment of a system and method for artificial intelligence-assisted virtual closing according to the teachings of the present disclosure; and

FIG. 3 is a more detailed flow diagram of an exemplary embodiment of a system and method for artificial intelligence-assisted virtual closing according to the teachings of the present disclosure.

### DETAILED DESCRIPTION

The mortgage closing process is traditionally very paper intensive and tedious. The buyer must affix wet signatures to a myriad of paper documents, and the lender must physically copy, distribute, register, and store the signed paper documents. A closing agent who may be an attorney from a title or mortgage company typically oversees the closing process. The closing process usually takes place at a title company or escrow office where the participants (buyer and seller) review and sign numerous legal documents under the scrutiny of a public notary. The mortgage closing process varies from state to state. This event is called a closing because the escrow account used to hold the earnest money and complete the property purchase is closed at the completion of the process. The required closing documents typically include a closing disclosure (Final Truth-in-Lending Disclosure) that lists all costs related to the transaction, including loan fees, real estate taxes, and other expenses; a promissory note that details the loan amount, interest rate, payment schedule, the term for repayment, and the penalties if the borrower fails to make routine mortgage payments; and a deed of trust that is a security instrument that pledges the property in question as security for the loan; and a deed that transfers property ownership or title of the property. The seller may also be required to furnish information on all known defects of the property, such as repair history, water damage, foundation issues, mold issues, infestations, lead paint, or malfunctioning systems.

MISMO® is the standards development body for the mortgage industry. The COVID-19 pandemic ushered in the rapid adoption by MISMO standards for Remote Online Notarization, digital closings, and electronic notes. The National eNote Registry is an electronic mechanism for identifying, tracking and verifying electronic promissory notes (eNotes) in a manner compliant with requirements imposed by the Uniform Electronic Transactions Act (UETA) and the federal Electronic Signatures in Global and National Commerce Act (ESIGN). UETA and ESIGN stipulate that the owner of an eNote (the Controller) has legal rights similar to those that a “Holder in Due Course’ has with a paper negotiable promissory note. ESIGN stipulates that eSignatures bear the same weight legally as wet signatures. Rounding out the eNote Registry are eCustodians or eVaults. Since the eNote Registry does not actually store the eNotes, proprietary electronic custodial repositories are used to store and manage eNotes.

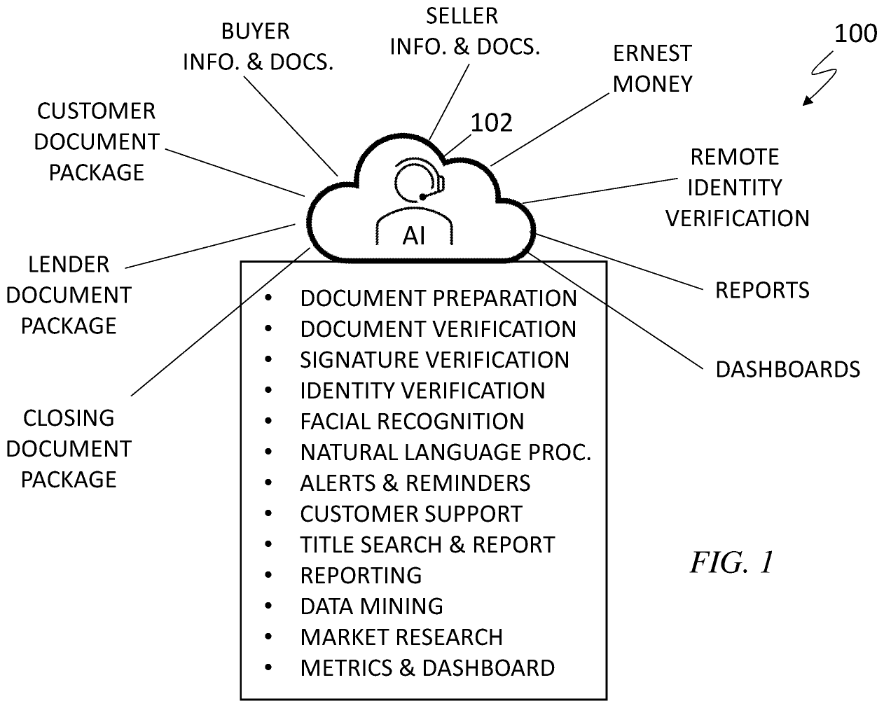

The adoption of virtual or remote closings is in alignment with a global economy where the parties to a transaction may not be located in the same state or country, and where travel is often disrupted by weather or other adverse conditions. FIG. 1 is a simplified block diagram that illustrates an artificial intelligence-assisted (AI-assisted) system and method 100 that facilitate and enable a buy-sell transaction that includes a remote or virtual closing. The system 100 is preferably an artificial intelligence-assisted cloud-based system 102 that is accessible by any internet-enabled computational device (e.g., mobile phone, laptop computer, notepad computer, and desktop computer) that is configured to connect to the system 102 via a wireless and/or wired connection using any communication protocol now known or to be developed.

The system and method 100 described herein use software applications executing on computing devices, including mobile devices (i.e., mobile apps), desktop computers, laptop computers, notebook computers, etc. to enable all of the parties in a closing (e.g., borrower/buyer, lender/broker, closing agent, and notary) to participate and complete the closing proceeding remotely and virtually. This includes identifying and verifying the participating parties who appear remotely by videoconference using optical character recognition (OCR), image analysis, and facial recognition, presenting documents to the participants for review and signature, enabling remote execution and notarizing of documents, effecting and enabling wiring or transfer of funds for the closing, storing/archiving the executed documents in a secure cloud-hosted database, and transmitting the executed documents to destinations that require the original or a copy of the documents in a secure manner. Further, the system and method may also assist in the preparation of closing documents themselves, remind the buyer/seller that they still need to supply a missing item of information or documentation, verify that all of the documents have been properly signed or initialed, provide customer support and answer questions, generate reports, etc. Additional tasks performed by the system and method may include providing a web portal that includes a one-stop easy-to navigate user interface that all participants may use to perform tasks associated with the transaction. The system and method may further incorporate a dashboard that enable the participants to see the real-time status of the transaction.

The system and method 100 include the job of collecting data/information/documents from all of the participating parties so that the closing documents may be generated. The system and method 100 use artificial intelligence (AI) technologies, including OCR, natural language processing, machine learning, speech/language understanding, image/facial recognition and analysis, etc. to facilitate, assist, and enable the data collection, document preparation, and closing process. An AI-assisted virtual assistant technology/software is used to facilitate communications with the closing participants via voice calls, text messages, email, mobile chat support, etc. The collected data and documentation are preferably stored in a secure database in the cloud.

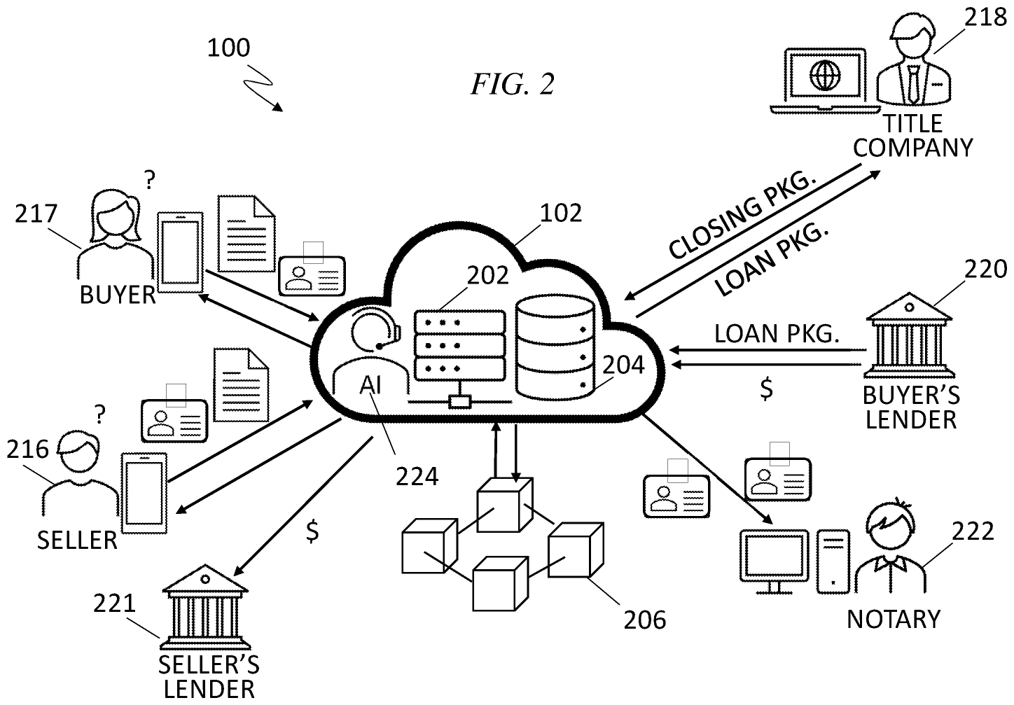

FIG. 2 is a more detailed block diagram of the AI-assisted system and method 100. The system and method 100 preferably include cloud-hosted server(s) 202 programmed to perform the tasks and database(s) 204 configured to securely store the collected data and documents. The database 204 may be protected by data encryption, password, and/or two-factor authentication. The system and method 100 may additionally search and access a blockchain land registry 206 to quickly verify and authenticate the title and chain of ownership, easements, use rights, change in marital status, and other encumbrances associated with the asset. The land registry blockchain 206 is a decentralized database system that securely store land ownership records at the national or municipal levels. The system and method 100 may incorporate smart contract technology to automate the process of executing the purchase agreement and recording the sale of the property on the blockchain 206, which makes the process secure, transparent, and tamper-proof.

The system and method 100 may provide a web portal that provides an easy to navigate user interface for all of the parties involved in the transaction, including the seller 216, buyer 217, title company/closing agent 218, real estate agent(s), lenders 220 and 221, and remote notary 222. The participants may easily upload and download documents via the portal assisted by the AI virtual assistant 224. After the seller and buyer execute the purchase contract and the buyer pays the earnest money, the real estate agent uploads the executed contract to the system and method 100 via the web portal and this document is then accessible to or is automatically transmitted to the title company 218. The title company 218 may automatically receive an alert that the executed contract is available for view and download. The title company 218 opens an escrow account and deposits the earnest money in the escrow account. The title company 218 may, using the AI virtual assistant 224, to search the title in a traditional way, or alternatively if available, in the land registry blockchain 206. The title company 218 may use the AI virtual assistant 224 to verify the legal history of the property, which includes a list of owners of record, liens, encumbrances, lawsuits, divorces, and any other factors that may put a cloud on the title or effect the transfer of the title. The AI virtual assistant 224 may automatically flag any issues it spots in the title record by sending alerts to the parties so that they can be addressed and cured. The buyer's lender 220 may also upload the loan package that contains the terms of the mortgage that the buyer will be committed to after the completion of the sale. The title company 218 will also incorporate the information and documents in the loan package in the closing package. The AI virtual assistant 224 may scan the documents in the closing package to ensure that there are no errors. For example, the calculations are correct, all of the purchase price dollar amounts matched between documents, there are no mis-spellings in the buyer/seller names and the legal description of the property is consistent and accurate, etc. The system and method 100 may also assist the title company 218 in preparing the closing documents. The AI virtual assistant 224 may automate the preparation of closing documents, such as purchase agreements and deeds, by pulling data from multiple documents and sources and ensuring that all necessary information is included.

The system and method 100 may assist in the collection of necessary information and documents from all participants so that the closing package can be properly prepared. The AI virtual assistant 224 may automatically contact the seller 216 and buyer 217 with a checklist to seek the needed information and documents and provide guidance in getting the information and documents uploaded to the system 100. The AI virtual assistant 224 may automatically send reminders and alerts to the participants if a needed piece of information or a document is still missing. For example, the AI virtual assistant 224 may send a text to the mobile phone of the buyer 217 that it still needs a copy of the buyer's government issued identification document, such as his driver's license. The AI virtual assistant 224 may also automatically assist in the scheduling of a closing date, arrange for the videoconference, and send reminders.

The system and method 100 may incorporate a dashboard that enables the participants to perceive, at a glance, the status of the transaction. For example, the seller may, at a glance, see that the title company is still waiting for a certain piece of information from the buyer, which is impeding the progress of closing document preparation. The dashboard brings much needed transparency to all participants so that progress can be made steadily and smoothly. As a part of the dashboard, admins of the system may be able to obtain various metrics related to each transaction, such as lapsed time to each milestone, e.g., how many days it took from engagement of the title company to closing.

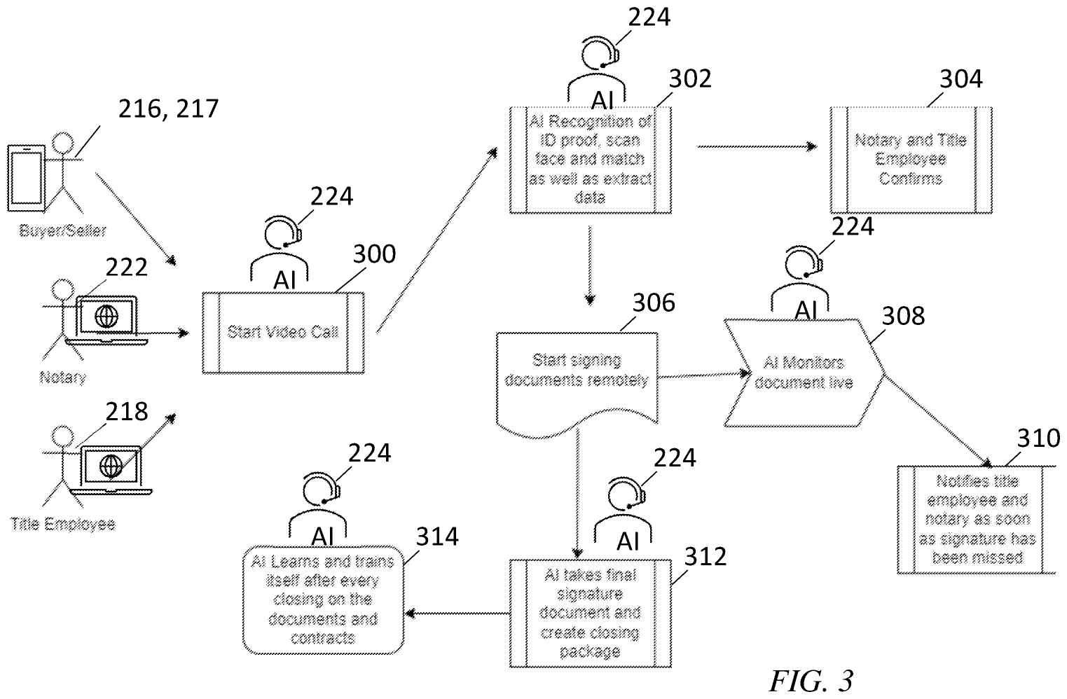

FIG. 3 is a simplified block diagram of an AI-assisted remote closing process according to the teachings of the present disclosure. In block 300, a videoconferencing session is commenced between the participants of the closing, including the seller 216, buyer 217, title company employee 218, and notary 222. The web portal may incorporate the videoconference function therein to facilitate the closing. Typically, the closing proceeds with the seller 216 first and then the buyer 217. The AI virtual assistant 224 may use facial recognition to scan and analyze the video images of the seller 216 and buyer 217 to verify against their government issued identification documents (e.g., passport, driver's license, etc.) that the individual appearing in the videoconferencing session is indeed the person they purport to be (block 302). Further verification processes may include using an ID verification API to automatically interface and communicate with state and/or federal government databases to validate the identity of the parties. Once the notary and title employee have, with the assistance of the AI virtual assistant, verified the identity of the seller/buyer (block 304), the seller/buyer may proceed to e-sign the closing documents remotely (block 306). The AI virtual assistant 224 may digitally present the documents to the seller/buyer in a way that is easy to read and sign. For example, instead of several different pdf documents, the closing documents may be presented in a way that the seller/buyer may flip through each page of the document sequentially, with clear demarcation between documents, and with the initial and signature locations clearly bookmarked and flagged. The system and method 100 may utilize a separate e-signature utility software or incorporate this functionality as part of the platform. Because there are a number of documents each with many pages that require the seller's and buyer's initials and signatures, the AI virtual assistant 224 actively monitors the signing and initialing of the document pages to ensure that any missing initial and signature is flagged in real-time (blocks 308 and 310). The AI virtual assistant 224 may alert the notary and/or title employee as soon as a page that should have received an initial or signature has been passed over. This way, missing initials and signatures are caught in real-time and corrective action can be taken immediately to obtain the missing items during the videoconference call.

After all of the closing documents have been reviewed and signed by the seller and buyer, the AI virtual assistant 224 organizes the documents and creates a closing package (block 312). This process may include, for example, splitting the pages into individual documents. This closing package is stored in the database 204 for access by the title company 218 for distribution or access by the seller and buyer. At the conclusion of every closing, the system and method 100 may use machine learning to analyze the entire transaction (including the recorded video and audio, documents, transaction metrics, etc.) to determine if there are improvements to be made to increase, for example, the efficiency of the procedures and closing process. Further, the system and method 100 may analyze the entire transaction (type of asset, size of asset, certain characteristics of asset, price point, location of asset, interest rate, type of loan, amount of down payment, lenders involved in the transaction, demographics of buyer/seller, etc.) for data mining, market research, and market trend analysis purposes.

It should be noted that the buy-sell transaction described herein is not limited to real estate property but the system and method may be utilized for closings of transactions to purchase and sell many types of assets, including residential real estate, commercial real estate, and personal property such as luxury yachts, recreational vehicles, sail boats, etc.

The features of the present invention which are believed to be novel are set forth below with particularity in the appended claims. However, modifications, variations, and changes to the exemplary embodiments of artificial intelligence assisted virtual real estate closing mobile app and process described above will be apparent to those skilled in the art, and the described herein thus encompasses such modifications, variations, and changes and are not limited to the specific embodiments described herein.

What is claimed is:

1. A system for an artificial intelligence-assisted virtual closing proceeding, comprising:
a web portal;
an artificial intelligence-assisted virtual assistant module configured to communicate and interface with a plurality of human participants for a closing proceeding selected from the group consisting of buyer, seller, lender, notary, closing agent, lawyer, and real estate agent via the web portal;
the virtual assistant module configured to communicate with a plurality of computing devices associated with the plurality of human participants to collect data and documents via the web portal, the plurality of computing devices being selected from the group consisting of mobile phones, laptop computers, notebook computers, notepad computers, and desktop computers;
the virtual assistant module configured to automatically prepare closing documents using information from the collected data and documents;
the virtual assistant module configured to automatically initiate a videoconferencing session for the virtual closing proceeding for the plurality of human participants via the plurality of computing devices; and
the virtual assistant module further configured to identify and verify the buyer and seller who appear remotely in the videoconferencing session via the plurality of computing devices, present the closing documents to the buyer and seller, enable remote execution of the closing documents by the buyer and seller via the plurality of computing devices, actively monitor the remote execution of the closing documents, enable and actively monitor remote notarizing of the closing documents, and store the executed documents in a secure database.

2. The system of claim 1, wherein the virtual assistant module is configured to automatically send a reminder to the plurality of human participants regarding missing data and documents.

3. The system of claim 1, wherein the virtual assistant module is configured to automatically receive a loan package from a lender via the web portal, and automatically prepare closing documents using information from the loan package.

4. The system of claim 1, wherein the virtual assistant module is configured to automatically employ at least one of facial recognition, optical character recognition, and image analysis to verify the identity of the buyer and seller participating in the videoconferencing session.

5. The system of claim 1, wherein the virtual assistant module is configured to communicate with the human participants using at least one of natural language processing and speech recognition.

6. The system of claim 1, wherein the virtual assistant module is configured to automatically scan the closing documents to check for errors.

7. The system of claim 1, wherein the virtual assistant module is configured to automatically flag missed initials or signatures during the videoconferencing session.

8. The system of claim 1, wherein the virtual assistant module is configured to automatically mine data associated with the closing proceeding for market research and market trend analysis purposes.

9. The system of claim 1, wherein the virtual assistant module is hosted in a cloud-based server.

10. The system of claim 1, wherein the virtual assistant module is configured to transmit the executed closing documents to at least one destination in a secure manner.

11. The system of claim 1, wherein the virtual assistant module is configured to automatically use machine learning to identify areas to improve efficiency and accuracy of the virtual closing proceeding.

12. The system of claim 1, wherein the virtual assistant module is configured to automatically schedule a date and time of the virtual closing proceeding with the human participants.

13. A method for an artificial intelligence-assisted virtual closing proceeding, comprising:
providing a web portal;
automatically communicating and interfacing with a plurality of human participants for a closing proceeding selected from the group consisting of buyer, seller, lender, notary, closing agent, lawyer, and real estate agent via the web portal;
automatically communicating with a plurality of computing devices associated with the plurality of human participants to collect data and documents via the web portal, the plurality of computing devices being selected from the group consisting of mobile phones, laptop computers, notebook computers, notepad computers, and desktop computers;
automatically preparing closing documents using information from the collected data and documents;
automatically initiating a videoconferencing session for the virtual closing proceeding for the plurality of human participants via the plurality of computing devices; and
automatically identifying and verifying the buyer and seller who appear remotely in the videoconferencing session via the plurality of computing devices, presenting the closing documents to the buyer and seller, enabling remote execution of the closing documents by the buyer and seller via the plurality of computing devices, actively monitoring the remote execution of the closing documents, enabling and actively monitoring remote notarizing of the closing documents, and storing the executed documents in a secure database.

14. The method of claim 13, further comprising automatically sending a reminder to the plurality of human participants regarding missing data and documents.

15. The method of claim 13, further comprising automatically employing at least one of facial recognition, optical character recognition, and image analysis to verify the identity of the buyer and seller participating in the videoconferencing session.

16. The method of claim 13, wherein communicating with the human participants comprises using at least one of natural language processing and speech recognition.

17. The method of claim 13, further comprising:
automatically scanning the closing documents to check for errors; and
automatically flagging missed initials or signatures during the videoconferencing session.

18. The method of claim 13, further comprising:
mining data associated with the closing proceeding for market research and market trend analysis purposes; and
using machine learning to identify areas to improve efficiency and accuracy of the virtual closing proceeding.

19. The method of claim 13, further comprising automatically scheduling a date and time of the virtual closing proceeding with the human participants.

20. The method of claim 13, further comprising using an ID verification API to automatically interface and communicate with a government database to validate the identity of the buyer and seller appearing in the videoconferencing session.
